(19) United States
(12) Patent Application Publication
(10) Pub. No.: US 2012/0189394 A1
(43) Pub. Date: Jul. 26, 2012

(54) MODULAR SPINDLE UNIT

(76) Inventor: Volker Meier, Lugde (DE)

(21) Appl. No.: 12/673,078

(22) PCT Filed: Aug. 14, 2008
(86) PCT No.: PCT/DE08/01323

§ 371 Date: Feb. 11, 2010

(30) Foreign Application Priority Data
Aug. 14, 2007 (DE) 10-2007-038-462.0
Jul. 30, 2008 (DE) 10-2008-035-523.2

(51) Int. Cl. B23B 39/16; B27C 3/04

(52) U.S. Cl. 408/130; 408/129

(57) ABSTRACT

The invention relates to a modular spindle unit for forming a multi-spindle machining head (36, 47, 49) for a machine tool, wherein the spindle unit (01, 30, 54) includes at least one drive spindle (02), to which a tool (37) or tool carrier (51, 52) is attachable, and wherein the spindle unit (01, 30, 54) includes a module housing (08, 31) in which the drive spindle (02) is mounted so as to be freely rotatable and axially displaceable. The module housing (08, 31) is attachable to the machining head (36, 47, 49) together with other module housings (08, 31), wherein the spindle unit (01, 30, 54) includes at least one drive motor (03), with which a drive spindle (02) allocated thereto is drivable in rotary manner, and wherein the center axis of the drive motor (03) and the center axis of the drive spindle (02) extend coaxially and define a unit center axis (07). The spindle unit (01, 30, 54) includes at least one axial actuating device (05), with which a drive spindle (02) allocated thereto is axially drivable in the direction of the unit center axis (07), wherein the center axis of at least one axial actuating device (05) and the unit center axis (07) extend coaxially. The drive motor (03) is mounted in the module housing (08, 31) so as to be axially displaceable and can be displaced axially in the module housing (08, 31) along the unit center axis (07) together with the drive spindle (02) by driving the axial actuating device (05).

The invention relates to a modular spindle unit for forming a multi-spindle machining head for a machine tool as described in the preamble of claim 1.

Multi-spindle machining heads that may be attached for example to the traverse drive of a machine tool are known from the related art. This particularly enables the machining head to be displaced and positioned in three axes. Tools, for example drills, milling heads or saw blades, may be attached to each of the different tool spindles of the machining head and may be driven in rotary manner. Such multi-spindle machining heads are used particularly in the furniture making industry to enable economical machining of panel-like parts, for example furniture fronts, carcasses, panels or insulating plates.

There are a number of different approaches with regard to the design and construction of such multi-spindle machining heads. According to a first construction type, all tool spindles are located in a solid gear block, which in turn consists of several bearing and distribution plates. This gear block must be designed and built afresh for each spindle arrangement, which is associated with high costs and long delivery times. It is also not possible to change the spindle arrangement and the number of spindles subsequently.

As an alternative to this, multi-spindle machining heads are also known in which the individual drive spindles are supported in modular spindle units. These modular spindle units are then combined to form the multi-spindle machining head and are attached to the machine tool as a single component.

Document DE 102 59 285 A1 describes modular spindle units that are designed without their own drive motor. The individual spindles are driven via a gear drive, which itself is driven by a central motor. The disadvantage of this design is that the individual working spindles cannot be driven individually and independently of each other, which means that it is not possible for them to rotate in different directions, function at different machining outputs, and dedicated sensor equipment cannot be associated with the spindles individually. Furthermore, the gear drive causes significant wear and therefore necessitates frequent servicing of the machinery.

Document DE 198 22 372 A1 describes a machining head that is formed from several spindle units, wherein the individual spindle units are attached to a common module carrier. Each of the spindle units is equipped with its own drive motor for rotary drive. Axial displacement drives are provided so that the spindle units may be extended relative to the module carrier independently of each other. The axial displacement drives are disposed offset parallel to the individual spindle units, and this has the disadvantage that it is not possible to arrange the spindle units correspondingly closely to the module carrier. Drilling patterns with very small drill spindle clearances, for example of just 30 mm, cannot be created in this way.

Document DE 101 20 883 A1 also describes a drilling unit having multiple spindle units, which may be displaced axially by axial drives that are offset parallel to the spindle units.

Document DE 199 50 715 A1 describes a machining head having multiple modular spindle units, in which the axial displacement drives are arranged coaxially with the center axis of the drive spindle. In this case, the drive spindle protrudes through the drive motor that is provided for rotary drive, and the drive motor itself is fixed with its spindle unit housing. In order to enable axial displacement of the drive spindle protruding through the drive motor, the rotor and a section of the drive spindle have a polygonal gear system, via which the driving torques may be transferred from the rotor of the drive motor to the drive spindle, and a push-fit system is created at the same time. The disadvantage of this engineering solution is that the polygonal gear system is very labor-intensive to manufacture. Moreover, the diameter of the spindle unit is increased substantially by the polygonal gear system between the drive spindle and the drive motor, and the spindle units are disposed correspondingly less closely together on the machining head. In addition, the gearing between the drive motor and the drive spindle may lead to undesirable rotary oscillations.

The object of the present invention is to suggest a new modular spindle unit for forming a multi-spindle machining head for a machine tool that does not suffer from the disadvantages of the related art described in the preceding. In this context, the aim is particularly to create a simple construction of the spindle unit and to enable the spindle units to be disposed very closely together on the machining head.

This object is achieved by the spindle unit according to the teaching of claim 1.

Advantageous embodiments of the invention are the objects of the dependent claims.

The invention is based on the underlying idea that axial movement between the drive motor and the drive spindle should be avoided. In this way, expensive and bulky means for transferring torque between the drive motor and the drive spindle, which also enable axial offset between the drive motor and the drive spindle, may be dispensed with. To achieve this object, the drive motor of the spindle unit according to the invention is mounted so as to be axially displaceable in the module housing, and may be displaced axially in the module housing by driving the axial actuating device together with the drive spindle along the common center axis. In other words, this means that the drive motor and the drive spindle form a single unit for the purpose of axial displacement. This results in very thin spindle units, which may be manufactured inexpensively. With volume production, preassembly and prior testing of the spindle units, the spindle units may be prefabricated with low type variance, and may be very quickly adapted for use with a wide range of multi-spindle machining head configurations as needed. In addition, rotary oscillations at the drive spindle are avoided. If the configuration of an existing machining head is to be altered, this may be easily carried out by simply dismounting and remounting the spindle units, since each spindle unit is a self-contained functional unit.

A particularly inexpensive and compact construction may be achieved if the rotor axle of the drive motor and the drive spindle are materially bonded to each other. To this end, the rotor axle of the drive motor and the drive spindle may be manufactured integrally as a single part, for example. In this way, elements for transferring torque between the rotor axle and the drive spindle may be dispensed with, since they are materially bonded to each other.

In particular, transferring drive energy and/or transferring information is essential in order to operate a drive motor. Normally, drive energy is transferred to the drive motor in the form of electrical energy. Because the drive motor is mounted so as to be axially displaceable in the module housing, hard-wired supply lines cannot be used for transferring the drive energy. It would be possible to use sliding contact rails, but this would necessitate considerable construction engineering effort and would also lead to significant safety problems. It is therefore particularly advantageous if the supply line for transferring drive energy has a length compensation element for adapting the length of the supply line. The length compensation element enables the geometry of the supply line to be adapted to the respective position of the drive motor in the module housing.

If the drive motor itself is driven electrically, the drive energy may be transferred via a power supply cable. In order to create the length compensation element, the power supply cable may include a spirally coiled section. The elasticity of such a spirally coiled section of the supply cable enables it to contract or extend within certain length limits, to thereby assuring the necessary length compensation.

Because it is flexible, the spirally coiled power supply cable must be routed on the spindle unit so as to avoid operating malfunctions. The spirally coiled power supply cable may be routed simply by winding the supply cable several times around a drive rod of the axial actuating device. In this context, the drive rod may be in the form of a kind of piston rod, for example, if the axial actuating device is driven electromechanically, pneumatically, or hydraulically. The drive rod thus extends through the coils of the power supply cable, so that the cable is held in place precisely on the drive rod.

In principle, this module housing of the individual spindle units may be of any structural design. According to a preferred embodiment, the module housing encloses two case plates and at least two rod axles. Each case plate forms the axial limit of the spindle unit. The rod axles connect the two case plates to each other and ensure that a fixed space remains between them. This forms a kind of open cage, which essentially constitutes the module housing and in which the various components of the spindle unit may be mounted, fixed to the housing, rotationally immovable, and/or axially displaceable. The use of thin rod axles enables the raster dimensions of the spindle units to be kept very small, which in turn allows the spindle units to be packed very tightly on the machining head.

In order to create a simple mounting for the drive motor in the module housing so that it is rotationally fixed and at the same time axially displaceable, the drive motor housing may be furnished with at least two apertures, through which the at least two rod axles extend. In this simple way, an axial mounting is provided for the drive motor housing in the module housing, wherein the drive motor may be braced on the module housing and at the same time is also axially displaceable within the module housing.

When manufacturing multi-spindle machining heads, it is often necessary for the drive spindles to be provided in pairs or in multiple combinations. In order to be able to realize these multi-spindle machining head constructions, in which several drive spindles together form a common group, in a simple manner, it is particularly advantageous if a spindle unit includes several drive spindles, particularly two or four drive spindles, each having an allocated drive motor and each having an allocated axial actuating device. In this way, the spindle unit forms an integrated modular component that includes several drive spindles. These integrated modular components in turn may then be preassembled and tested in advance, and then combined simply to form multi-spindle machining heads.

In order for a multi-spindle machining head to be operated properly, it is very important for the drive spindle to be controlled precisely, otherwise it is not possible to ensure that the tool is positioned correctly relative to the machining location on the work piece, for example in order to make a drill hole. To provide a simple means for realizing this, it is particularly advantageous if a bearing sleeve is fixed to the drive motor, in which bearing sleeve the drive spindle is mounted so as to be able to rotate freely and/or is axially immovable. In this way, the drive motor and the mounting for the drive spindle in the bearing sleeve form a mechanically connected unit, thereby completely preventing any dimensional deviations between the drive motor and the drive spindle mounting. This is particularly important with respect to the spindle unit according to the invention because the drive motor is axially displaceable together with the axial spindle.

In this context, the bearing sleeve for mounting the drive spindle may serve at the same time as the mounting for the rotor of the drive motor, and a separate mounting for the rotor of the drive motor may be dispensed with. This construction is particularly advantageous if the rotor of the drive motor and the drive spindle are connected to each other as a single part, for example by use of a through-axle.

In order to prevent the tool that is in engagement from becoming misaligned relative to the unit center axis, the case plate of the module housing may be furnished with an aperture. The bearing sleeve passes through this aperture in the case plate and braces the case plate so that the bearing sleeve cannot be forced to one side.

The bearing sleeve is retained in the aperture in the case plate particularly precisely if the aperture forms a push-fit system. In other words, this means that the aperture then forms a slide bearing for the bearing sleeve, in which the bearing sleeve is axially displaceable. The center axis of the bearing sleeve is centered radially on the center axis of the unit.

When a tool is fixed on the spindle unit and is in engagement with a work piece, the axial forces that must be applied in the machining zone are often very great, for example when a drill is used to drill a hole. In order to be able to absorb these strong axial forces with the axially displaceable drive spindle in a simple manner on the module housing, it is particularly advantageous if the bearing sleeve is furnished with a locating groove. A bolt of a locking device may then engage in positive locking manner in the locating groove and thus secure the bearing sleeve axially to the module housing. Locking the axially displaceable part to the module housing in particular also relieves the stress on the axial actuating device, which no longer has to absorb any axial forces after the locking is in effect. As a result, correspondingly less robust axial actuating devices are required.

A particularly compact and small locking device may be produced if locking and unlocking is performed by a magnetic actuating device.

It is also particularly advantageous if the locking device is arranged on the outside of the module housing, particularly on the outside of the case plate that holds the bearing sleeve in place axially. In this way, no additional installation space is required between the spindle units, so the maximum packing density of the spindle units on the multi-spindle machining head is not limited.

The axial actuating device should preferably be constructed in the form of a pneumatic actuating cylinder with axially drivable drive piston.

In this regard, the free end of the piston rod of the drive piston may be attached mechanically to the drive motor housing, to that it is able to axially displace the drive motor and the drive spindle connected thereto.

In order to enable a more compact construction, one preferred embodiment provides that the module housing forms the pneumatic actuating cylinder and the drive motor housing forms the pneumatic drive piston of the spindle unit. In other words, this means that a further step towards functional integration is taken, with the result that the components of the pneumatic axial drive are formed by existing components, that is to say by the module housing and the drive motor housing. The drive motor housing is already suitable to serve as the pneumatic drive piston, since the drive motor housing is regularly cylindrical in shape and may thus easily be sealed in a cylindrical retainer in the module housing. The advantage of this embodiment is that many components that would otherwise be needed to form the pneumatic axial actuating device may thus be dispensed with. A piston rod for transferring the axial propulsion from the drive piston to the drive motor is also not required. Overall, this results in an extremely compact construction.

If the drive piston for the pneumatic axial actuating device is formed by the drive motor housing, the lines for transmitting drive energy between the module housing and the drive motor should be routed through the pneumatic actuating cylinder.

In order to prevent the rotationally driven drive motor from spinning relative to the module housing that forms the pneumatic actuating cylinder, a combination of a support groove and a support element acting in positive locking manner may serve to brace against torque instead of using guide rods. In this case, the support groove is machined into the cylindrical piston area of the pneumatic actuating cylinder so that the support element attached to the drive motor housing is able to engage in positive locking manner in the support groove to brace against torque. This integration of the torque bracing in the actuating cylinder of the pneumatic axial actuating device enables an even more compact construction, since in particular the guide rods may be dispensed with.

In order to create the most compact construction possible, it is particularly advantageous if the pneumatic control unit for positioning the drive piston in the actuating cylinder is arranged on the rear end of the module housing. In this context, prismatic or cylindrical cross sections of the control unit should align with the prismatic or cylindrical cross section of the module housing, such that when several spindle units are arranged one beside the other there are no overlaps on the individual spindle units, and it is thus possible to pack the spindle elements very closely together.

The spindle unit drive motor is preferably designed as a type of variable servomotor with sensor equipment. In particular, it is advantageous if the direction of rotation of the spindle unit is freely selectable, so that the direction of rotation may be determined for each individual tool on the multi-spindle machining head independently of the other tools. Information for describing the machining operation may also be collected and uploaded with sensor equipment appropriate for the purpose. In this way, it is possible, for example, to detect a tool failure or wear of the tool on the spindle unit and respond accordingly. In particular, a positional sensor means also makes it possible to position each tool individually on the multi-spindle machining head, without reference to the other tools, so that a tool may be changed.

In order to increase functional integration yet further, the electronic controller of the servomotor may be fixed to the allocated module housing, Alternatively, it is also conceivable to connect the controller to the servomotor via a cable and locate it somewhere else entirely.

A module housing carrier may be provided so that multiple spindle units may be fixed in the correct position on the multi-spindle machining head. The individual spindle units are secured exactly in position on the module housing carrier one at a time and independently of the other spindle units, which in turn prevents the accumulation of positional errors, such as occur when the individual spindle units are secured to each other.

In order to position the spindle units as exactly as possible on the module housing carrier, an aperture may be provided on the module housing carrier for each spindle unit. The bearing sleeve of the drive spindle then passes through this aperture to form a push-fit system, in which the bearing sleeve is axially displaceable. In this way, an exact radial positioning of the unit center axis is ensured by the position of the apertures in the module housing carrier. Each individual unit center axis is then positioned and centered independently of the other spindle units on the module housing carrier.

In order to enable the spindle units to be attached to the module housing in simple manner at least two apertures may be provided on the module housing carrier for each spindle unit. The ends of the module housing rod axles are then located in these apertures.

It is particularly advantageous if in embodiments of the module housing that have two rod axles for each spindle unit in the module housing carrier, four apertures are provided for attaching the rod axles. In this case, these four apertures should preferably be arranged at the corners of a square. In this way, the spindle unit may be attached with its two rod axles to the module housing carrier in various relative positions, since each rod axle may be attached diagonally offset in the four apertures.

In order to further increase the degree of modularity, the module housing carrier may also be constructed from a number of standardized module components. Module housing carriers that are created modularly from a module construction system in this way may be used for fabricating multi-spindle machining heads quite generally and regardless of the construction of the spindle units, since standardized modular components may be used to create module housing carriers in a wide variety of geometric shapes, and using a small number of non-variable parts is favorable for inexpensive, uncomplicated production. By using standardized module components, it is thus possible to define the geometric shape of the machining head first, by carefully combining module components so as to avoid manufacturing order-specific, complex single parts in order to produce the housing carrier that supports the spindle units.

Standardized plate elements in particular are most suitable for creating such a module construction system. Even with just a few such standardized plate elements, to which two, three, four or more spindle units may be attached, it is possible to form multi-spindle machining heads with practically any geometry. To this end, the individual plate elements are combined in at least two layers in accordance with the desired geometry, the individual plate elements in each respective adjacent layer being arranged in overlapping manner to form a mechanically solid transition between the individual plate elements. Then, the plate elements of the module housing carrier are attached in fixed manner to each other, for example glued together. Accordingly, a wide variety of geometries may be created for the multi-spindle machining heads from a small number or standardized module components.

According to a further aspect of the invention, a tool carrier is arranged at least on one spindle unit of the machining head, which tool carrier includes its own drive motor so that it is able to drive a separate drive spindle in rotary manner. In other words, this means that the spindle unit essentially only serves to displace the tool carrier axially, whereas the drive motor in the tool carrier is tasked with the rotary drive of the tool. This enables a wide range of functions to be performed, for example horizontal drilling, milling, sawing.

The drive motor may be removed, that is to say dismounted or omitted, on spindle units that have a tool carrier that has its own drive motor, since it is often not necessary for the tool carrier to be driven rotationally. Tool carriers that are equipped with their own drive motor may be used for creating multi-spindle machining heads quite generally and independently of the spindle unit configuration. This particularly makes is possible to integrate complex production functions, for example swiveling C-axes, in conventional spindle arrays, particularly vertical drill spindle arrays. Thus for example, special designs for these complex production functions may be avoided. Equally, the spindle unit may also be used as a stand-alone unit, in the case of separate universal processing machines for example.

It is particularly advantageous if the drive spindle in the tool carrier is at right angles to the drive spindle of the spindle unit in the machining head. In particular, this enables horizontal drilling, horizontal milling, or circular saw functions to be carried out.

If the tool carrier is swivelable about a swivel axis of a spindle unit, the function of the swivel drive may be performed by the rotary drive of one of the drive spindles in the machining head.

Various embodiments of the invention are shown schematically in the drawing and will be explained in the following for exemplary purposes.

In the drawing:

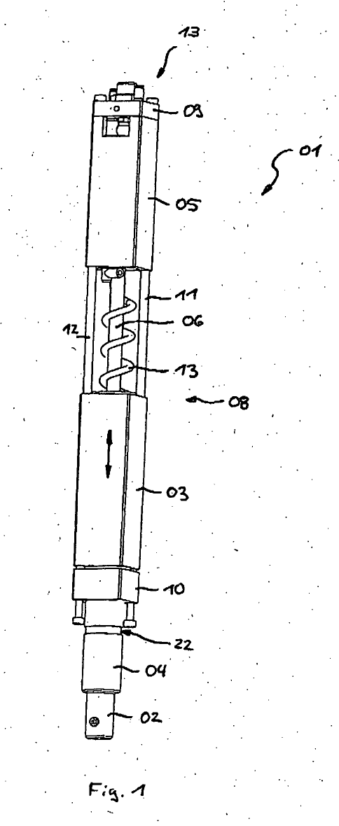

FIG. 1 is a perspective view of a first embodiment of a spindle unit;

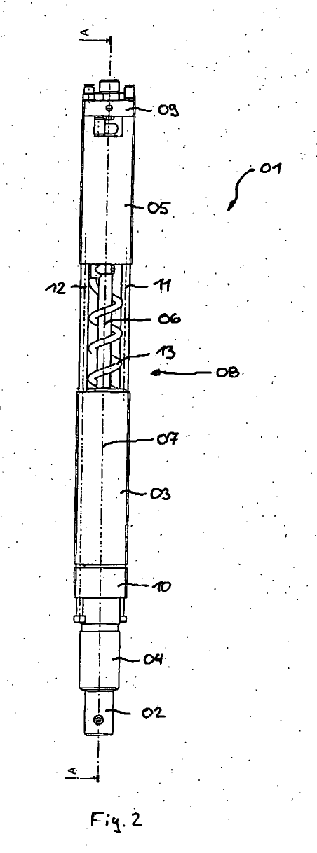

FIG. 2 is a side view of the spindle unit of FIG. 1;

FIG. 3 is a longitudinal view of the spindle unit of FIG. 2 along section line I-I;

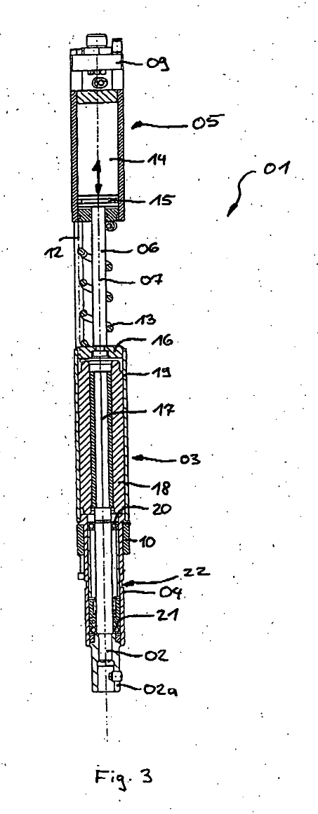

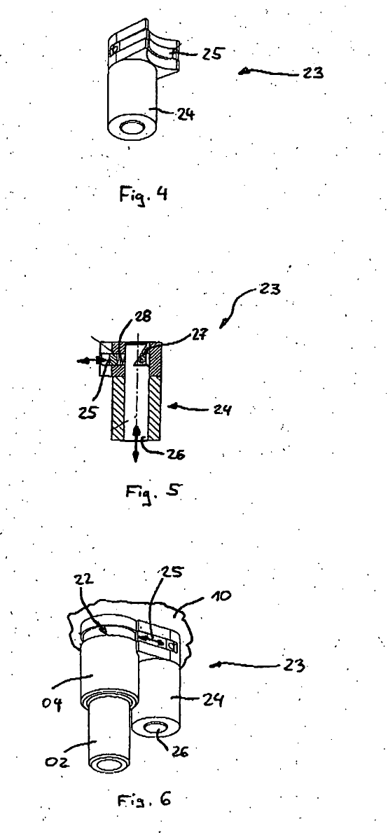

FIG. 4 is a perspective view of a locking device for use on the spindle unit of FIG. 1;

FIG. 5 is a longitudinal section of the locking device of FIG. 4;

FIG. 6 is a perspective view of the locking device of FIG. 4 arranged on a spindle unit;

FIG. 7 is a perspective view of a second embodiment of a spindle unit having two drive spindles and two drive motors;

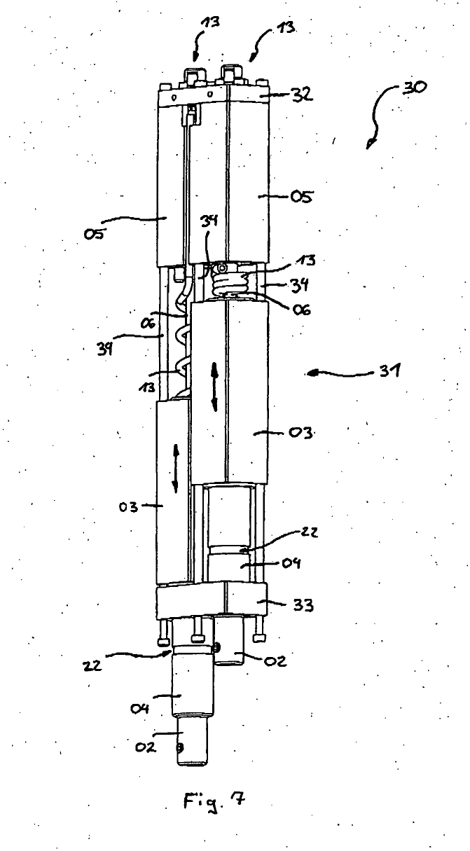

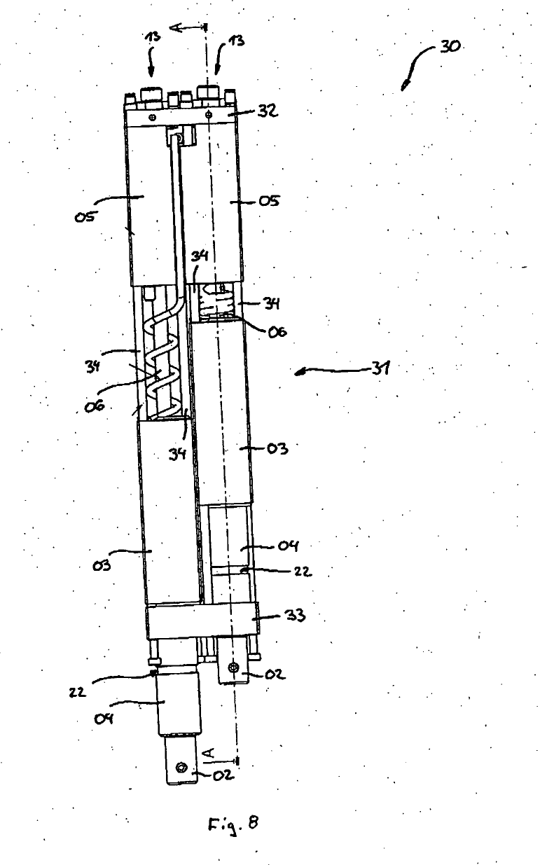

FIG. 8 is a side view of the spindle unit of FIG. 7;

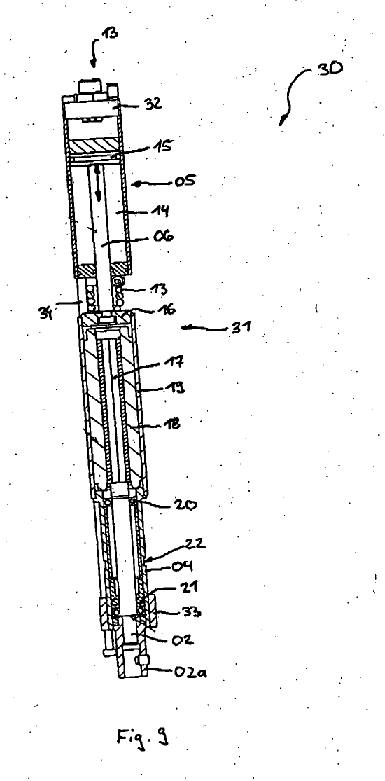

FIG. 9 is a longitudinal section of the spindle unit of FIG. 8 along section line II-II;

FIG. 10 is a perspective view from above of a multi-spindle machining head that has been created by mounting several spindle units as shown in FIG. 7 on a module housing carrier;

FIG. 11 is a perspective view of a standardized module component for creating module housing carriers;

FIG. 12 is a perspective view of various embodiments of standardized module components for creating module housing carriers;

FIG. 13 is a perspective view of a module housing carrier created from the standardized module components shown in FIG. 11;

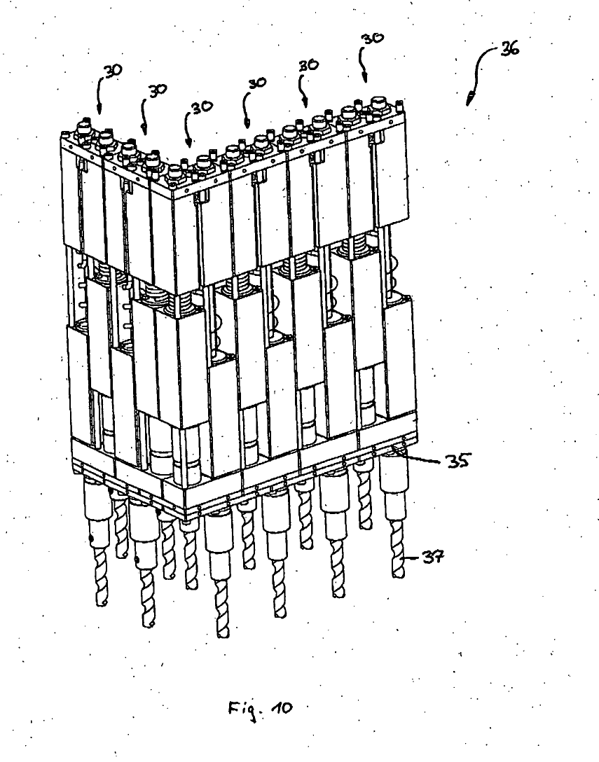

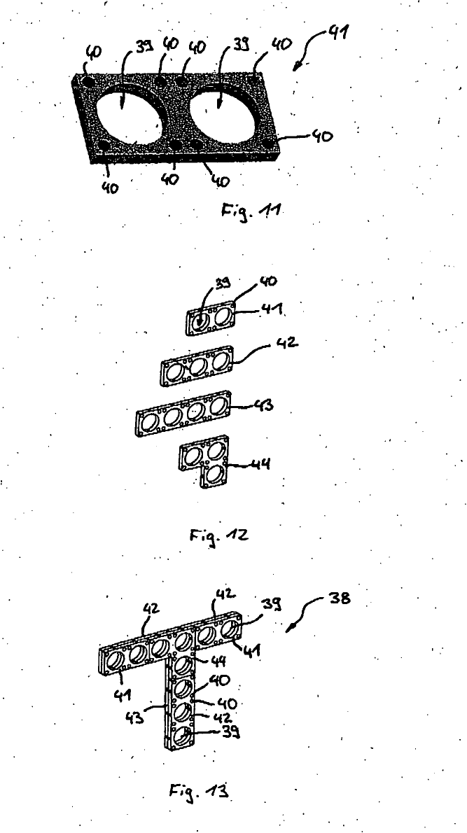

FIG. 14 is a perspective view from below of the multi-spindle machining head of FIG. 10 after the housing case has been attached;

FIG. 15 is a perspective view from below of a second embodiment of a multi-spindle machining head;

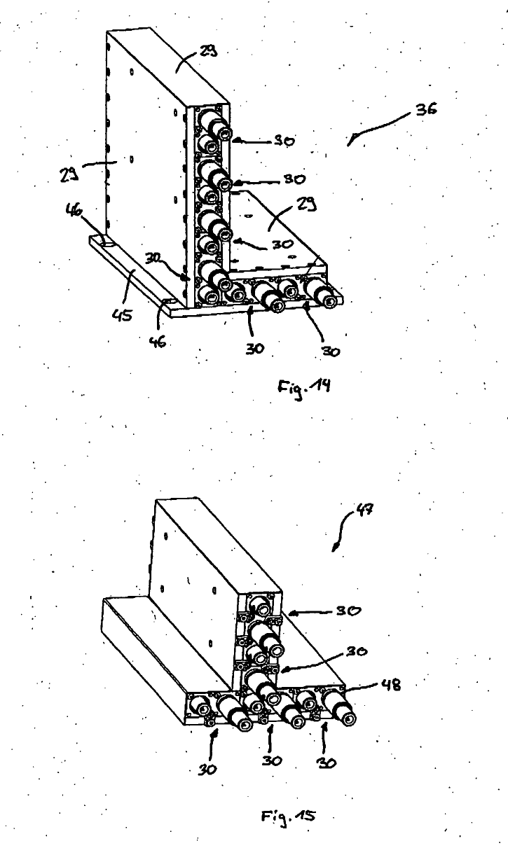

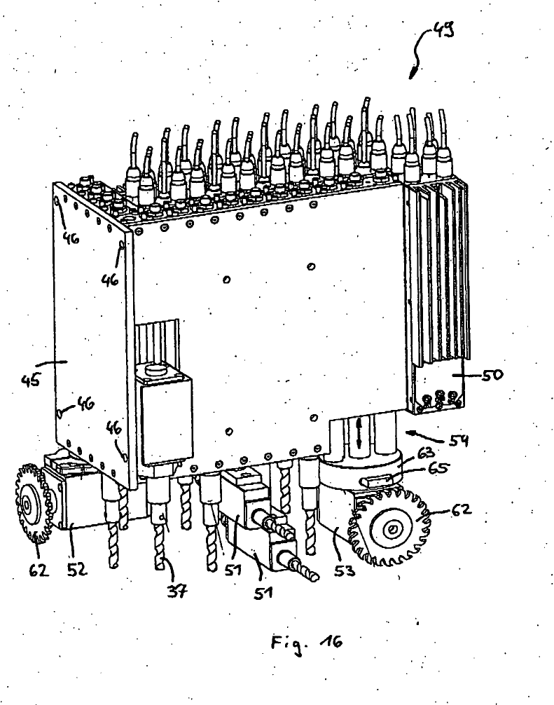

FIG. 16 is a perspective view from above of a third embodiment of a multi-spindle machining head;

FIG. 17 is a second perspective view of the multi-spindle machining head of FIG. 16;

FIG. 18 is a perspective view of a tool carrier of the multi-spindle machining head of FIG. 16;

FIG. 19 is a cross sectional view of the tool carrier of FIG. 18;

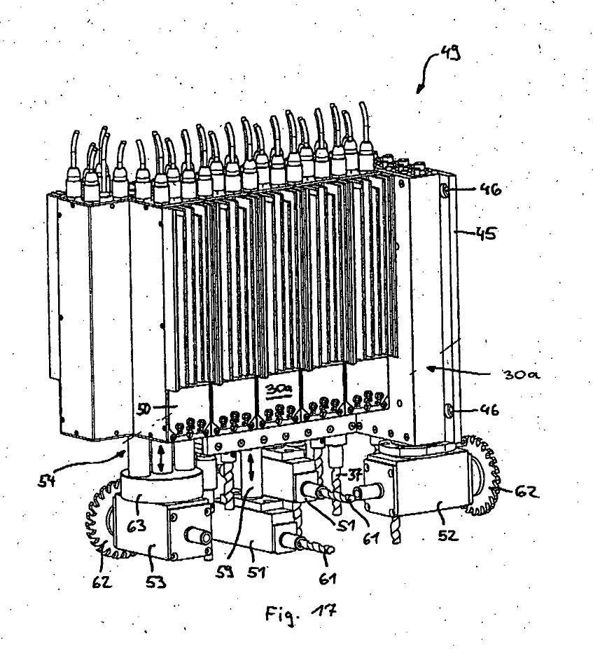

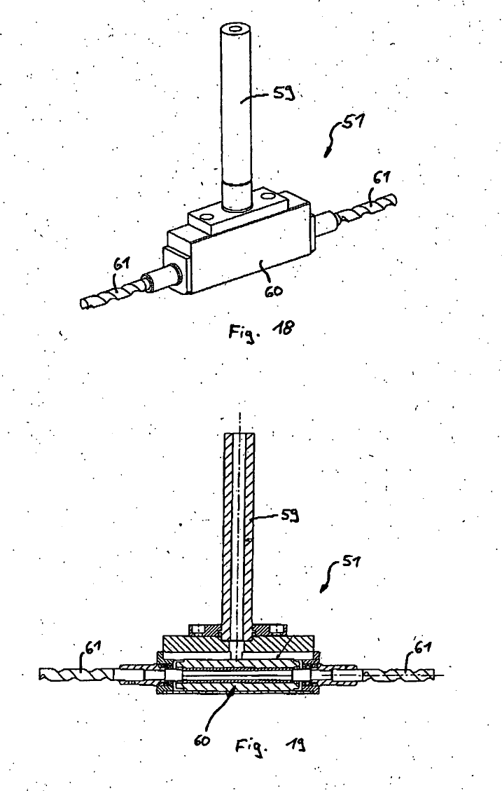

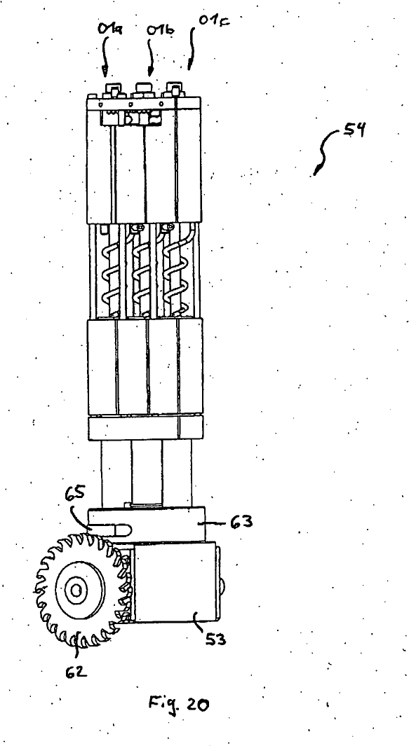

FIG. 20 is a side view of a third embodiment of a spindle unit with a tool carrier arranged thereon for use on the multi-spindle machining head of FIG. 16;

FIG. 21 is a longitudinal section of the spindle unit with tool carrier of FIG. 20;

FIG. 22 is a perspective view of a further embodiment of a spindle unit with two drive spindles and two drive motors;

FIG. 23 is a first side view of the spindle unit of FIG. 22;

FIG. 24 is a second side view of the spindle unit of FIG. 22;

FIG. 25 is a longitudinal view of the spindle unit of FIG. 23 along section line III-III;

FIG. 26 is a longitudinal view of the spindle unit of FIG. 23 along section line IV-IV;

FIG. 28 is a side view of a drive motor of the spindle unit of FIG. 22 functioning as a pneumatic drive piston;

FIG. 29 is a longitudinal section of the drive motor of FIG. 28;

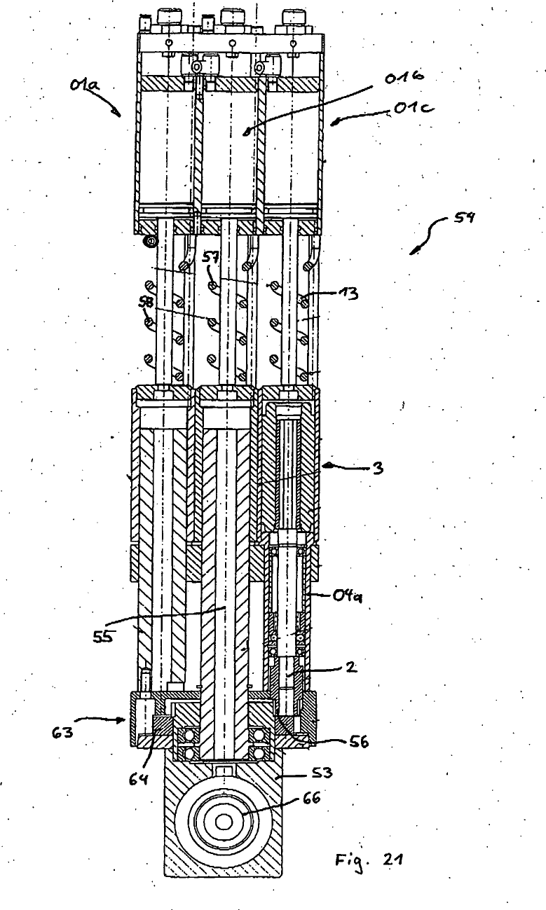

FIG. 30 is a top view of the drive motor of FIG. 28;

FIG. 31 is a longitudinal section of the module housing of the spindle unit of FIG. 22;

FIG. 32 is an enlarged cross section of the module housing of FIG. 31 along section line V-V.

FIG. 1 is a perspective view of a first embodiment 01 of a modular spindle unit. Spindle unit 01 has a drive spindle 02 that is drivable in rotary manner and to which a tool, for example a drill or milling machine, or a tool carrier is attachable. Drive spindle 02 is driven in rotary manner by an electric drive motor 03, whose rotor shaft is connected as a single piece to drive spindle 02. Drive spindle 02 is mounted so as to be rotatable on a bearing sleeve 04 whose upper end is connected in rotationally fixed manner to the housing of drive motor 03. An axial actuating device 05 in the form of a pneumatic cylinder with a piston rod 06 serves to displace drive motor 03, bearing sleeve 04, and drive spindle 02 axially. Piston rod 06 may be extended and retracted axially, piston rod 06 being connected to the housing of drive motor 03 and thus also moves drive motor 03, bearing sleeve 04 which is attached thereto, and drive spindle 02, which is held in place inside the bearing sleeve.

FIG. 2 is a side view of spindle unit 01 with its unit center axis 07. It shows that the center axis of drive motor 03 and the center axis of drive spindle 02 run coaxially and thus define unit center axis 07. The center axis of axial actuating device 05 also runs coaxially with this unit center axis 07. The various components of spindle unit 01 are fixed and mounted in a cage-like module housing 08. Module housing 08 essentially consists of an upper case plate 09, a lower case plate 10, and two rod axles 11 and 12 that connect case plates 09 and 10 to each other mechanically, and keep a fixed distance between them. Axial actuating device 05 is connected in fixed manner to module housing 08, and is immovable relative to module housing 08. Connectors 13 for connecting spindle unit 01 to the pneumatic compressed air supply and the electric or electronic controller are located on the top of upper case plate 09. The housing of drive motor 03 has elongated holes in two corners, through which rod axles 11 and 12 protrude. In this way, drive motor 03 is able to be displaced axially in the direction of the unit center axis on rod axles 11 and 12, and at the same time is supported in non-rotating manner thereon, so that it is able to transfer a driving torque to drive spindle 02.

A spirally coiled supply cable 13, which is wound round piston rod 05, serves to supply drive motor 03 with electrical energy and also to enable data to be exchanged between the controller and drive motor 03, which is configured as a servomotor with sensor equipment. Because of its elasticity, supply cable 13 is able to compensate for the longitudinal change in position of drive motor 03 relative to module housing 08, and is also held in position by piston rod 06.

FIG. 3 is a longitudinal section of spindle unit 01. It shows axial actuating device 05 with its pneumatic drive cylinder 14, which may be driven with compressed air to move a drive piston and the piston rod 06 connected thereto axially back and forth in the direction of unit center axis 07. Drive motor 03 and its housing cover 16 is attached mechanically to piston rod 06, so that the actuating motion of axial actuating device 05 may be transferred to motor 03. Rotor axle 17 of drive motor 03 is driven in rotary manner via an electric stator 18. In this context, drive motor 03 may advantageously have the form of a servomotor with suitable sensor equipment, for example for monitoring the power consumption and position of rotor 17.

Rotor axle 17 is integrally connected to drive spindle 02, and a tool attachment module 02a is provided on the free end of drive spindle 02 for mechanically connecting a tool, for example a drill, to the drive spindle.

Roller bearings 20 and 21 ensure that drive spindle 02 and rotor axle 17 are mounted so as to be movable in rotary manner and axially fixed relative to bearing sleeve 04, which is fixed to the bottom end of housing 19 of drive motor 03. Bearing sleeve 04 passes through lower case plate 10 in an aperture with surface tolerance. The surface tolerance of the internal diameter of the aperture in case plate 10 and of the external diameter of bearing sleeve 04 is selected in the manner of a slide bearing, such that a push-fit system is created. In this push-fit system, bearing sleeve 04 may be displaced axially through case plate 10, while unit center axis 07 is radially centered.

A locating groove 22 is machined into the middle of the outer side of bearing sleeve 04 and protrudes beyond module housing 08 when bearing sleeve 04 is extended axially. This locating groove serves to axially secure the axially movable parts of spindle unit 01.

FIGS. 4 to 6 show a locking device 23, which cooperates with locating groove 22 to fix spindle unit 01 axially. A bolt 25 on locking device 23 is retractable and extendable by means of a magnetic actuating device 24 to disengage and engage in positive locking manner with locating groove 22. If a voltage is applied to magnetic actuating device 24, a drive pin 26 is shifted axially and forces bolt 25 backwards with a spline groove 27 so that it disengages from locating groove 22. When electrical energy is removed, bolt 25 is forced forward by the biasing force of a spring element 28 and is able to engage in locating groove 22. Because of its compact construction, locking device 23 may be arranged between very closely adjacent spindle units. This is particularly facilitated by the fact that locking device 23 is arranged on the bottom of case plate 10, which forms the outside of module housing 08.

FIGS. 7 to 9 show a second embodiment 30 of a modular spindle unit. Spindle unit 30 differs from spindle unit 01 in that two drive spindles 02 are provided, and these are always installed in pairs. Of course, it is also conceivable to produce spindle units with a different number of drive spindles, for example with four drive spindles.

Each of drive spindles 02 is in turn mounted so as to be rotatable and free of axial play, and is drivable with its own drive motor 03 and may be axially displaced by an axial actuating device 05. Module housing 31 of spindle unit 30 is formed by an upper case plate 32, a lower case plate 33 and four rod axles 34, which are arranged in pairs. The axially displaceable mounting of drive motors 03 on rod axles 34 is equivalent in principle to spindle unit 01. Case plate 33 is furnished with two apertures, equal to the number of bearing sleeves 04, forming a push-fit system for each bearing sleeve 04. Otherwise, the construction of spindle unit 30 follows the same principle as that of spindle unit 01.

A module housing carrier may be used for positioning spindle units 01 or 30 relative to each other. A module housing carrier 35 of such kind for creating a multi-spindle machining head 36 is illustrated for exemplary purposes in FIG. 10. Each of six spindle units 30 are attached to two drive spindles 02, which are provided in pairs, on module housing carrier 35. Each of the spindle units 30 is attached directly to module housing carrier 35, independently of the other spindle units, to avoid cumulative positioning errors. The multi-spindle machining head 36 created in this way may be equipped with up to twelve tools, such as twelve drills 37, to produce an L-shaped drilling pattern. Drive spindles 02 are independently drivable in rotary manner, and independently extendable axially, and it is also possible to monitor machining operations at each individual drill 37 using appropriate sensor equipment.

FIGS. 11 to 13 of the drawing are intended to explain the creation of a module housing carrier. The module housing carrier 38 shown in perspective in FIG. 12 is constructed in a T shape and has a total of 10 apertures 39, which serve as push-fit systems for bearing sleeves 04 and enable drive spindles 02 to be aligned precisely on module housing carrier 38. When spindle units 01 or 30 are mounted on module housing carrier 38, bearing sleeves 04 are pushed through apertures 39 and are aligned in this way. Then, case plates 10 or 33 are secured by screwing fixing bolts through apertures 40. The fixing bolts protruding through apertures 40 may also be used for fixing rod axles 34 or 11 and 12.

The geometry of the drilling pattern for the multi-spindle machining head to be created is determined by the geometry of module housing carrier 38. Standardized module components are suggested that will enable a large number of module housing carrier geometries to be produced with standardized, prefabricated components.

FIGS. 11 and 12 show perspective views of such module components, which are constructed in the manner of plate elements 41, 42, 43 and 44. Plate elements 41 to 43 are each of different lengths and are provided with a different number of apertures 29. Plate element 44 is intended for use as a corner connector.

To build module housing carrier 38, two plate elements 42 and one plate element 43 are laid out as in a T-shape as the first layer on a jig. Then, a second layer, including two plate elements 41, a corner plate element 44, and one plate element 42, are laid on top of the first layer with the same geometry. The end faces of the plate elements overlap in both layers. The jig that is used preferably has aligning bolts with dimensional tolerances, on which the plate elements are placed using apertures 39, to ensure that the plate elements are aligned relative to each other and dimensions are retained.

The two layers are then bonded to each other mechanically, for example by adhesion. In this way, a very large variety of module housing carriers with differing dimensions and geometries may be created from standardized module components 41 to 44.

FIG. 14 shows the multi-spindle machining head 36 after housing cladding 29 has been attached. A fixing plate 45 with fixing holes 46 is also provided on one side, the holes being used for connecting the multi-spindle machining head to a machine tool.

FIG. 15 shows an alternative geometry of a multi-spindle machining head 47 for creating a T-shaped drilling pattern. Multi-spindle machining head 47 consists of five spindle units 30 and one T-shaped module housing carrier 48.

FIGS. 16 and 17 show another embodiment 49 of a multi-spindle machining head. Also shown on the cladding of multi-spindle machining head 49 are the connection points for electronic controllers 50, each of which is assigned to a drive motor. A number of the spindle units 01 and 30 are provided on multi-spindle machining head 49 and simple vertical drills 02 are attached to the drive spindles 02 thereof.

In addition, four spindle units are shown, the drive spindles of which are attached to tool carriers 51, 52 and 53. Tool carriers 51, 52 and 53 are each equipped with their own drive motor and are independent of the rotary drive in spindle units 01 and 30. The spindle units 30a that are assigned to tool carriers 51, 52 and 53 are only used for axial displacement and for connecting tool carriers 51, 52 and 53 to the respectively assigned electronic controllers 50, therefore they do not have their own drive motor.

FIGS. 18 and 19 show a tool carrier 51 in perspective and cross-sectional views respectively. Tool carrier 51 is connected in non-rotating manner to an extension bushing 59, the top end of which is attachable in non-rotating manner to the bearing sleeve 04 of a spindle unit 01 or 30. A drive motor 60, in the form of a variable servomotor, is provided in tool carrier 51, and drives two horizontal drills 61. The drive motion of the spindle unit 01 or 30 provided on tool carrier 51 is not transferred to horizontal drill 61. With horizontal drills 61, horizontal drill holes may be made perpendicularly to the drilling direction of vertical drills 37.

Tool carrier 52 (see FIG. 17) drives a saw blade 62 and may be swiveled about the unit center axis by hand. Tool carrier 53 is also equipped with a saw blade 62, and may be swiveled by driving a drive shaft.

FIGS. 20 and 21 show spindle unit 54, on which tool carrier 53 is retained. The construction of spindle unit 54 is essentially obtained by combining the basic components of three modified spindle units 01a, 01b, and 01c. Spindle units 01a, 01b and 01c undergo certain construction engineering modifications so that spindle unit 54 will fit on tool carrier 53. In particular, the two spindle units 01a and 01b have no drive motors 03 of their own. This version of spindle unit 54, which supports tool carrier 53 on the machining head enables such a tool carrier 53 to be integrated without difficulty in an array of spindle units 01 or 30 provided on the machining head.

Three axial actuating devices 05 are provided for positioning tool carrier 53 axially. Tool carrier 53 may be rotated through 360 degrees about unit center axis 55. A drive motor 03 is used as the slewing drive for swiveling tool carrier 53, the drive spindle 02 of which drive motor engages via a gearing 56 with slewing gear 63 that is arrestable by a clamping device 64 and is fixed to tool carrier 53. The clamping device is in the form of a conical brake flange and is actuated by the non-rotating piston. In addition, a position sensor 65 is provided inside slewing gear 63 to monitor the slewing angle of tool carrier 53.

The electrical connection between drive motor 66 in tool carrier 53 and position sensor 65 in slewing gear 63 is assured by spirally wound connecting cables 57 and 58, which are longer than connection cable 13 with which drive motor 03 in spindle unit 54 is connected.

FIG. 22 is a perspective view of another embodiment 67 of a modular spindle unit. Spindle unit 67 also has two drive spindles 02, which are also fitted in pairs. Each of the drive spindles 02 in the pair may be driven in rotary manner by its own electric drive motor 68. Drive motors 68 may also be displaced axially in module housing 69 by pneumatic means, and may thus be extended forward and retracted backward. In this case, housings 70 of drive motors 68 serve as pneumatic drive pistons, which seal off a pneumatic actuating cylinder in module housing 69. A pneumatic controller 71 is attached to the side of module housing 69 facing away from spindles 02, and the pneumatic actuating valves for axial displacement of drive motors 68 are installed here. Controller 71 also contains the electrical connections for energy supply to drive motors 68. At the same time, the cross section of controller 71 is exactly the same as the prismatic cross section of module housing 69, so that multiple spindle units 67 may be arranged as closely together as possible and attached to a module housing carrier. Bearing sleeves 04 of spindles 02 are themselves axially displaceable and essentially supported free of radial play in a case plate 33, thereby forming a push-fit system for bearing sleeves 04.

FIGS. 23 and 24 show two side views of spindle unit 67, wherein in the illustrated views the one drive spindle 02 is retracted and the other drive spindle 02 is extended.

FIG. 25 shows spindle unit 67 along section line III-III through the drive spindle when it is retracted into module housing 69. Module housing 69 includes two pneumatic drive cylinders 72 and 73, in which a pneumatic overpressure or underpressure may be generated by actuating pneumatic valves in controller 71. Then, the motor housings 70 of drive motors 68 functioning as pneumatic drive pistons are axially extended or retracted according to the pressure conditions in pneumatic drive cylinders 72 and 73. In order to seal the motor housing 70 that functions as a drive piston off from pneumatic drive cylinder 72 or 73, two gaskets 74 each are fitted around the outer circumference of motor housings 70.

One spirally wound line 75, only indicated in FIG. 25, passes inside each of pneumatic cylinders 72 and 73 to supply drive motor 68 with electrical energy. Line 75 extends from a connector at the rear end of drive motor 68 to the connectors in controller 71.

In order to provide torque support for drive motor 68 against module housing 69, a bracing element 76 is attached to the rear extremity of drive motor 68, extends radially slightly beyond the cylindrical periphery of housing 70 of drive motor 68, and engages in a support groove 77 in the piston bearing surface 78 of both pneumatic actuating cylinders 72 and 73. The slight radial protrusion by bracing element 76 with respect to housing 70 is particularly visible in FIG. 30. The bracing element is a circular plate which is screwed onto the back of housing 70 of drive motor 68.

FIGS. 31 and 32 show support groove 77, which extends in the direction of the longitudinal axis of the spindle units in the piston bearing surface of both actuating cylinders 72 and 73. Only the support groove in actuating cylinder 72 is shown in FIG. 31. The support grooves 77 are slightly longer than the maximum stroke of both drive motors 68 with respect to module housing 69 (compare FIG. 25 with FIG. 26). The arrangement of support groove 77 in the upper half of actuating cylinders 72 and 73 also ensures that gaskets 74 are seated below support grooves 77 in each case, and adequate sealing of actuating cylinders 72 and 73 at all times is assured thereby.

### Legend

| | |
|---|---|
| 01 | Modular spindle unit |
| 02 | Drive spindle |
| 03 | Drive motor |
| 04 | Bearing sleeve |
| 05 | Axial actuating device |
| 06 | Piston rod |
| 07 | Unit center axis |
| 08 | Module housing |
| 09 | Upper case plate |
| 10 | Lower case plate |
| 11 | Rod axle |
| 12 | Rod axle |
| 13 | Connector |
| 14 | Pneumatic drive cylinder |
| 15 | Pneumatic drive piston |
| 16 | Housing cover (motor housing) |
| 17 | Rotor axle |
| 18 | Stator |
| 19 | Motor housing |
| 20 | Roller bearing |
| 21 | Roller bearing |
| 22 | Locating groove |
| 23 | Locking device |
| 24 | Magnetic actuating device |
| 25 | Bolt |
| 26 | Drive pin |
| 27 | Spline groove |
| 28 | Spring element |
| 29 | Housing cladding |
| 30 | Modular spindle unit |
| 31 | Module housing |
| 32 | Upper case plate |
| 33 | Lower case plate |
| 34 | Rod axle |
| 35 | Module housing carrier |
| 36 | Multi-spindle machining head |
| 37 | Drill |
| 38 | Module housing carrier |
| 39 | Aperture |
| 40 | Aperture |
| 41 | Plate element |
| 42 | Plate element |
| 43 | Plate element |
| 44 | Plate element |
| 45 | Fixing plate |
| 46 | Fixing hole |
| 47 | Multi-spindle machining head |
| 48 | Module housing carrier |
| 49 | Multi-spindle machining head |
| 50 | Electric controller |
| 51 | Tool carrier with drive motor |
| 52 | Tool carrier with drive motor |
| 53 | Tool carrier with drive motor |
| 54 | Modular spindle unit |
| 55 | Unit center axis |
| 56 | Gearing |
| 57 | Connection cable |
| 58 | Connection cable |
| 59 | Extension bushing |
| 60 | Drive motor |
| 61 | Horizontal drill |
| 62 | Saw blade |
| 63 | Slewing gear |
| 64 | Clamping device |
| 65 | Position sensor |
| 66 | Drive motor |
| 67 | Spindle unit |
| 68 | Drive motor |
| 69 | Module housing |
| 70 | Motor housing |
| 71 | Controller |
| 72 | Pneumatic actuating cylinder |
| 73 | Pneumatic actuating cylinder |
| 74 | Gasket |
| 75 | Electrical connection line |
| 76 | Bracing element |
| 77 | Support groove |
| 78 | Piston bearing surface |

1-35. (canceled)

36. A modular spindle unit for forming a multi-spindle machining head for a machine tool, comprising:
at least one drive spindle, to which a tool or tool carrier is attachable;
a module housing in which the drive spindle is mounted so as to be freely rotatable and axially displaceable, the module housing is attachable to the machining head together with other module housings;
at least one axial actuating device, with which a drive spindle allocated thereto is axially drivable in the direction of the unit center axis and wherein the center axis of at least one axial actuating device and the unit center axis extend coaxially; and
at least one drive motor, with which a drive spindle allocated thereto is drivable in rotary manner, and wherein the center axis of the drive motor and the center axis of the drive spindle extend coaxially and define a unit center axis, the drive motor is mounted in the module housing so as to be axially displaceable and can be displaced axially in the module housing along the unit center axis together with the drive spindle by driving the axial actuating device.

37. The spindle unit as recited in claim 36, wherein the module housing includes two case plates at the two axial ends of the spindle unit, and at least two rod axles, wherein the rod axles particularly run parallel to the unit center axis and connect the two case plates to each other mechanically with a fixed distance therebetween.

38. The spindle unit as recited in claim 36, wherein at least two apertures are provided in the housing of the drive motor for mounting the drive motor so as to be rotationally fixed and axially displaceable, and which the rod axles of the module housing pass through to form an axial mounting.

39. The spindle unit as recited in claim 36, wherein the spindle unit includes a plurality of drive spindles with a drive motor allocated to each, and with an axial actuating device allocated to each.

40. The spindle unit as recited in claim 39, wherein the spindle unit includes two or four drive spindles.

41. The spindle unit as recited in claim 36, wherein a bearing sleeve is attached to the drive motor, in which the drive spindle is mounted so as to be freely rotatable and/or axially fixed,

42. The spindle unit as recited in claim 41, wherein a rotor axle of the drive motor is mounted in the bearing sleeve so as to be freely rotatable and/or axially fixed.

43. The spindle unit as recited in claim 41, wherein a case plate of the module housing is furnished with at least one aperture, through which the bearing sleeve of the drive spindle passes through the case plate.

44. The spindle unit as recited in claim 43, wherein at least one of the aperture(s) forms a push-fit system, in which the bearing sleeve is axially displaceable and which centers the center axis of the bearing sleeve radially with the unit center axis.

45. The spindle unit as recited in claim 36, wherein the axial actuation device is constructed in the manner of a pneumatic actuating cylinder with a particularly dual-action, axially drivable drive piston, wherein in particular the free end of a piston rod fixed to the drive piston is mechanically connected to the housing of the drive motor.

46. The spindle unit as recited in claim 45, wherein the module housing serves as the pneumatic actuating cylinder and the housing of the drive motor serves as the pneumatic drive piston.

47. The spindle unit as recited in claim 46, wherein a line for transferring drive energy between the module housing and the drive motor runs through the pneumatic actuating cylinder.

48. The spindle unit as recited in claim 46, wherein a support groove is provided in a cylindrical piston bearing surface of the pneumatic actuating cylinder, in which a bracing element fixed to the housing of the drive motor engages in positive locking manner so that the drive motor is mounted in a non-rotating and axially displaceable manner.

49. The spindle unit as recited in any of claim 45, wherein a pneumatic controller for positioning the drive piston in the actuating cylinder is arranged at the rear end of the module housing and wherein a prismatic or cylindrical cross section of the controller aligns with a prismatic or cylindrical cross section of the module housing.

50. The spindle unit as recited in claim 36, wherein an electronic controller of the drive motor is attached to the allocated housing of the allocated spindle unit.

51. The spindle unit as recited in claim 36, wherein a module housing carrier is provided for fixing multiple spindle units in the correct position on the machining head, and to which the spindle units are attachable individually being exactly positioned relative to each other.

52. The spindle unit as recited in claim 51, wherein an aperture is provided for each spindle unit in the module housing carrier for positioning the spindle units on the module housing carrier, through which aperture the bearing sleeve of the drive spindle of the individual spindle units passes through the module housing carrier

53. The spindle unit as recited in claim 52, wherein the aperture in the module housing carrier forms a push-fit system in which the bearing sleeve is held in place radially and is axially displaceable.

54. The spindle unit as recited in claim 51, wherein at least two apertures are provided on the module housing carrier for fixing the spindle units to the module housing carrier, and to which the respective ends of the rod axles of the module housings are attachable.

55. The spindle unit as recited in claim 54, wherein four apertures per spindle unit are provided on the module housing carrier for fixing the spindle units to the module housing carrier, and to which the respective ends of the rod axles of the module housings are attachable.

56. The spindle unit as recited in claim 36, wherein a tool carrier is arranged on at least one spindle unit of the machining head, wherein the tool carrier is axially displaceable with the axial actuating device of the spindle unit, and wherein the tool carrier includes its own drive motor, with which a tool is drivable in rotary manner.

57. The spindle unit as recited in claim 56, wherein, in spindle units including a tool carrier with its own drive motor, the drive motor is removed from the spindle unit, and/or the axis of rotation of a tool provided on a tool carrier is perpendicular to the unit center axis of the allocated spindle unit in the machining head, and/or the tool carrier is mounted on the spindle unit so as to be swivelable about the unit center axis, and/or the drive spindle of a spindle unit engages with the tool carrier and the tool carrier can be swiveled about the unit center axis by driving the drive spindle.
